(19) United States
(12) Patent Application Publication
(10) Pub. No.: US 2023/0333644 A1
(43) Pub. Date: Oct. 19, 2023

(54) Arranging Virtual Objects

(71) Applicant: Apple Inc., Cupertino, CA (US)

(72) Inventors: Jordan A. Cazamias, San Francisco, CA (US); Aaron M. Burns, Sunnyvale, CA (US); David M. Schattel, Santa Clara, CA (US); Jonathan Perron, Felton, CA (US); Jonathan Ravasz, Sunnyvale, CA (US); Shih-Sang Chiu, Menlo Park, CA (US)

(21) Appl. No.: 18/123,837

(22) Filed: Mar. 20, 2023

Related U.S. Application Data
(63) Continuation of application No. PCT/US2021/049024, filed on Sep. 3, 2021.
(60) Provisional application No. 63/081,990, filed on Sep. 23, 2020.

(51) Int. Cl. G06F 3/16; G06F 3/01

(52) U.S. Cl. CPC G06F 3/013; G06F 3/017; G06F 3/167

(57) ABSTRACT

Various implementations disclosed herein include devices, systems, and methods for organizing virtual objects within an environment. In some implementations, a method includes obtaining a user input corresponding to a command to associate a virtual object with a region of an environment. A gaze input corresponding to a user focus location in the region is detected. A movement of the virtual object to an object placement location proximate the user focus location is displayed.

### CROSS-REFERENCE TO RELATED APPLICATIONS

This application is a continuation of Intl. Pat. App. No. PCT/US2021/49024, filed on Sep. 3, 2021, which claims priority to U.S. Provisional Patent App. No. 63/081,990, filed on Sep. 23, 2020, which are incorporated by reference in their entirety.

### TECHNICAL FIELD

The present disclosure generally relates to displaying virtual objects.

### BACKGROUND

Some devices are capable of generating and presenting graphical environments that include virtual objects and/or representations of physical elements. These environments may be presented on mobile communication devices.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1E illustrate example operating environments according to some implementations.

FIG. 2 depicts an exemplary system for use in various computer enhanced technologies.

FIG. 3 is a block diagram of an example virtual object arranger according to some implementations.

FIGS. 4A-4C are flowchart representations of a method for organizing virtual objects within an extended reality (XR) environment in accordance with some implementations.

FIG. 5 is a block diagram of a device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### SUMMARY

Various implementations disclosed herein include devices, systems, and methods for organizing virtual objects within an extended reality (XR) environment. In some implementations, a method includes detecting a gesture corresponding to a command to associate a virtual object with a region of an XR environment. A gaze input corresponding to a user focus location in the region is detected. A movement of the virtual object to an object placement location based on the user focus location is displayed.

In accordance with some implementations, a device includes one or more processors, a non-transitory memory, and one or more programs. In some implementations, the one or more programs are stored in the non-transitory memory and are executed by the one or more processors. In some implementations, the one or more programs include instructions for performing or causing performance of any of the methods described herein. In accordance with some implementations, a non-transitory computer readable storage medium has stored therein instructions that, when executed by one or more processors of a device, cause the device to perform or cause performance of any of the methods described herein. In accordance with some implementations, a device includes one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example implementations described herein.

A person can interact with and/or sense a physical environment or physical world without the aid of an electronic device. A physical environment can include physical features, such as a physical object or surface. An example of a physical environment is physical forest that includes physical plants and animals. A person can directly sense and/or interact with a physical environment through various means, such as hearing, sight, taste, touch, and smell. In contrast, a person can use an electronic device to interact with and/or sense an extended reality (XR) environment that is wholly or partially simulated. The XR environment can include mixed reality (MR) content, augmented reality (AR) content, virtual reality (VR) content, and/or the like. With an XR system, some of a person’s physical motions, or representations thereof, can be tracked and, in response, characteristics of virtual objects simulated in the XR environment can be adjusted in a manner that complies with at least one law of physics. For instance, the XR system can detect the movement of a user’s head and adjust graphical content and auditory content presented to the user similar to how such views and sounds would change in a physical environment. In another example, the XR system can detect movement of an electronic device that presents the XR environment (e.g., a mobile phone, tablet, laptop, or the like) and adjust graphical content and auditory content presented to the user similar to how such views and sounds would change in a physical environment. In some situations, the XR system can adjust characteristic(s) of graphical content in response to other inputs, such as a representation of a physical motion (e.g., a vocal command).

Many different types of electronic systems can enable a user to interact with and/or sense an XR environment. A non-exclusive list of examples include heads-up displays (HUDs), head mountable systems, projection-based systems, windows or vehicle windshields having integrated display capability, displays formed as lenses to be placed on users’ eyes (e.g., contact lenses), headphones/earphones, input systems with or without haptic feedback (e.g., wearable or handheld controllers), speaker arrays, smartphones, tablets, and desktop/laptop computers. A head mountable system can have one or more speaker(s) and an opaque display. Other head mountable systems can be configured to accept an opaque external display (e.g., a smartphone). The head mountable system can include one or more image sensors to capture images/video of the physical environment and/or one or more microphones to capture audio of the physical environment. A head mountable system may have a transparent or translucent display, rather than an opaque display. The transparent or translucent display can have a medium through which light is directed to a user’s eyes. The display may utilize various display technologies, such as uLEDs, OLEDs, LEDs, liquid crystal on silicon, laser scanning light source, digital light projection, or combinations thereof. An optical waveguide, an optical reflector, a hologram medium, an optical combiner, combinations thereof, or other similar technologies can be used for the medium. In some implementations, the transparent or translucent display can be selectively controlled to become opaque. Projection-based systems can utilize retinal projection technology that projects images onto users’ retinas. Projection systems can also project virtual objects into the physical environment (e.g., as a hologram or onto a physical surface).

The present disclosure provides methods, systems, and/or devices for organizing virtual objects within an extended reality (XR) environment. In various implementations, an electronic device, such as a smartphone, tablet, or laptop or desktop computer, displays virtual objects in an extended reality (XR) environment.

A user may use gestures to manipulate virtual objects in the XR environment. For example, the user may use a pinching gesture to select a virtual object. The user may use a pulling gesture to move the virtual object in the XR environment. Accordingly, pinching and pulling gestures can be used to select and move a virtual object with a high degree of control over the placement of the virtual object. However, using these gestures to organize virtual objects in the XR environment may involve significant effort, e.g., large gestures performed by the user.

In various implementations, a user may perform a gesture that corresponds to a command to place a virtual object in an XR environment. For example, the user may perform a flinging gesture in connection with a selected virtual object. In response to detecting this gesture, an electronic device may determine a user focus location in the XR environment based on a gaze input obtained from the user. The electronic device may determine an object placement location based on the user focus location and may associate the virtual object with the object placement location. A movement of the virtual object to the object placement location is displayed in the XR environment. Placement of the virtual object may be guided by the gaze of the user, rather than by potentially large gestures, thereby reducing user inputs (e.g., reducing the size and/or number of user inputs) involved in organizing virtual objects in the XR environment. Reducing the need for unnecessary user inputs tends to prolong a battery life of a battery-operated device, thereby improving operability of the device.

The object placement location may be at least a threshold distance from another object in the XR environment. For example, if another object is close to the user focus location, the object placement location may be located near the user focus location, but at least the threshold distance from the other object. As another example, a movement of the other object may be displayed to accommodate placement of the virtual object at the user focus location.

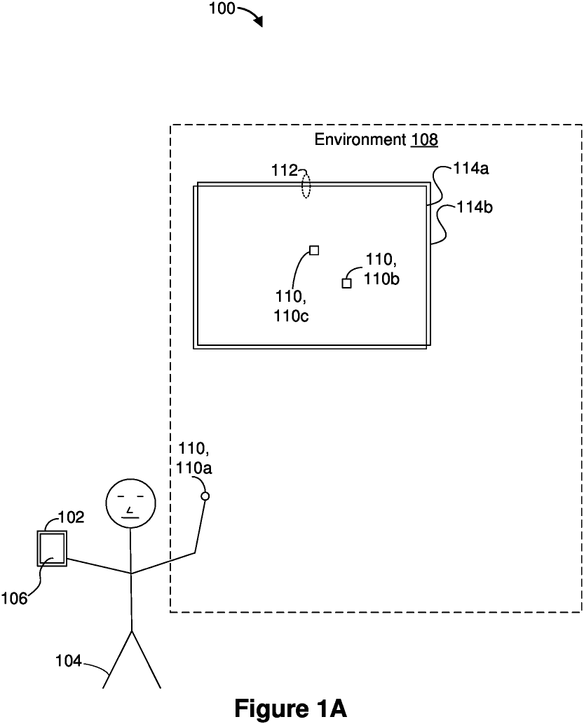

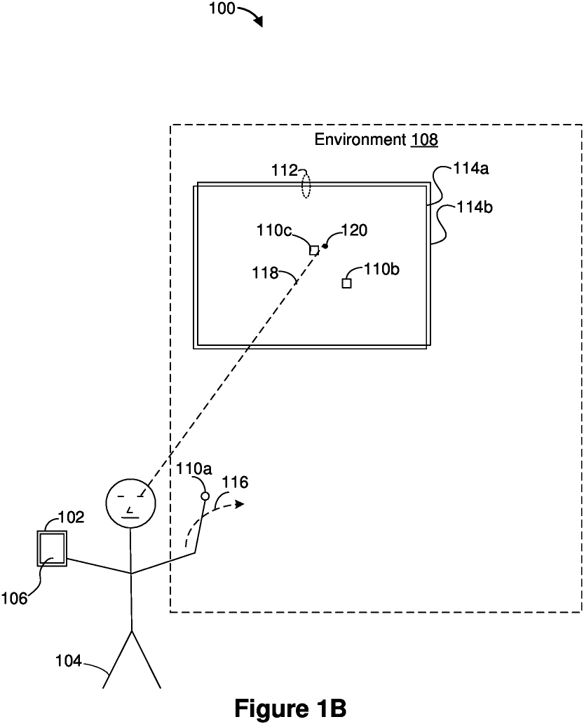

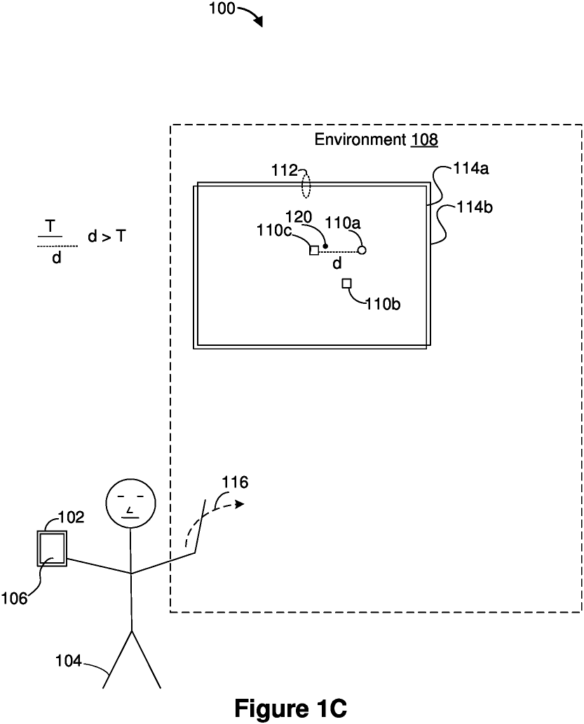

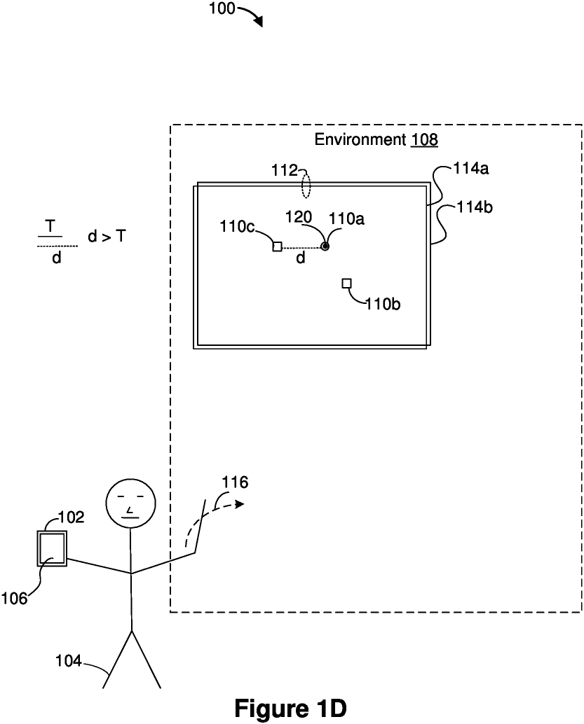

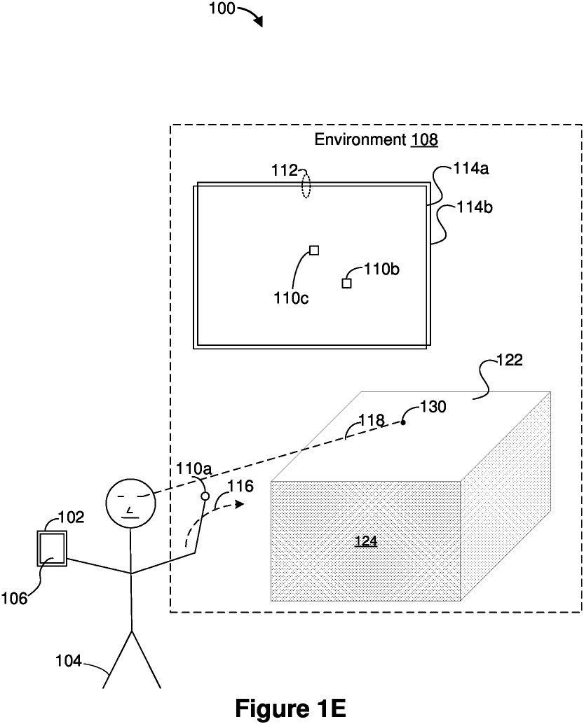

FIG. 1A is a diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes an electronic device 102 and a user 104.

In some implementations, the electronic device 102 includes a handheld computing device that can be held by the user 104. For example, in some implementations, the electronic device 102 includes a smartphone, a tablet, a media player, a laptop, or the like. In some implementations, the electronic device 102 includes a desktop computer. In some implementations, the electronic device 102 includes a wearable computing device that can be worn by the user 104. For example, in some implementations, the electronic device 102 includes a head-mountable device (HMD), an electronic watch or a pair of headphones. In some implementations, the electronic device 102 is a dedicated virtual assistant device that includes a speaker for playing audio and a microphone for receiving verbal commands. In some implementations, the electronic device 102 includes a television or a set-top box that outputs video data to a television.

In various implementations, the electronic device 102 includes (e.g., implements) a user interface engine that displays a user interface on a display 106. In some implementations, the display 106 is integrated in the electronic device 102. In some implementations, the display 106 is implemented as a separate device from the electronic device 102. For example, the display 106 may be implemented as an HMD that is in communication with the electronic device 102.

In some implementations, the user interface engine displays the user interface in an extended reality (XR) environment 108 on the display 106. The user interface may include one or more virtual objects 110a, 110b, 110c (collectively referred to as virtual objects 110) that are displayed the XR environment 108. As represented in FIG. 1A, the user 104 has selected the virtual object 110a. For example, the user 104 may have interacted with the virtual object 110a using gestures, such as pinch and/or pull gestures, to manipulate the virtual object 110a. The virtual objects 110b and 110c are displayed in a region 112. In some implementations, the region 112 is a bounded region. For example, the region 112 may include a two-dimensional virtual surface 114a enclosed by a boundary and a two-dimensional virtual surface 114b that is substantially parallel to the two-dimensional virtual surface 114a. The virtual objects 110b, 110c may be displayed on either of the two-dimensional virtual surfaces 114a, 114b. In some implementations, the virtual objects 110b, 110c are displayed between the two-dimensional virtual surfaces 114a, 114b.

As shown in FIG. 1B, the electronic device 102 may obtain a user input corresponding to a command to associate the virtual object 110a with the region 112. For example, the electronic device 102 may detect, via an image sensor, a gesture 116 performed by the user, such as a flinging gesture. In some implementations, the electronic device 102 obtains a gaze input 118 corresponding to a user focus location 120 in the region 112. For example, a user-facing image sensor may determine a gaze vector. The electronic device 102 may determine the user focus location 120 based on the gaze vector.

As shown in FIG. 1C, in some implementations, the electronic device 102 determines an object placement location based on the user focus location 120 of FIG. 1B. The object placement location is proximate the user focus location 120. In some implementations, if another object (e.g., the virtual object 110c) is also proximate the user focus location 120, the object placement location may be selected so that it is at least a threshold distance T from the virtual object 110c. A movement of the virtual object 110a to the object placement location may be displayed in the XR environment 108.

As shown in FIG. 1D, in some implementations, the electronic device 102 selects the object placement location to coincide with the user focus location 120 of FIG. 1B. The electronic device 102 displays a movement of the virtual object 110a to the object placement location, e.g., to the user focus location 120. If another object (e.g., the virtual object 110c) is also proximate the user focus location 120, the electronic device 102 may display a movement of the virtual object 110c so that it is at least a threshold distance T from the virtual object 110a when the virtual object 110a is displayed at the object placement location.

In some implementations, as represented in FIG. 1E, the gaze input 118 may correspond to a user focus location 130 in a region 122 associated with a physical element 124 in the XR environment 108. The region 122 may be associated with a portion of the physical element 124. For example, as represented in FIG. 1E, the region 122 is associated with a top surface of the physical element 124. In some implementations, when the movement of the virtual object 110a to the object placement location is displayed, the appearance of the virtual object 110a is altered. For example, a display size of the virtual object 110a may be determined as a function of a size of the physical element, e.g., so that the virtual object 110a is scaled proportionately to the physical element 124. As another example, the virtual object 110a may be rotated based on an orientation of the physical element 124, e.g., to align with the physical element 124.

In some implementations, the electronic device 102 determines an object placement characteristic (e.g., a placement location, a size, and/or visual properties such as color, opacity, etc.) for the virtual object 110a based on a type of a target location. In some implementations, the target location includes an application (e.g., a whiteboard application, a messaging application, etc.), and the electronic device 102 determines the object placement characteristic based on properties of the application (e.g., based on a GUI layout of the application and/or based on rules for placing virtual objects within the application). For example, if the target location is a messaging application that includes an input field for typing messages, the electronic device 102 places a reduced-size version of the virtual object 110a in the input field of the messaging application even when the user 104 is gazing elsewhere in the messaging application. For example, if the user 104 flings an image towards the messaging application while gazing at a sent/received messages area of the messaging application, the electronic device 102 places a reduced-size version of the image in the input field of the messaging application. As another example, if the target location is a whiteboard application with a defined boundary (e.g., as shown in FIGS. 1A-1E) and placing the object at the user focus location would cause a portion of the object to be displayed outside the boundary of the whiteboard application, the electronic device 102 places the virtual object 110a at a location other than the user focus location such that an entirety of the virtual object 110a is displayed with the boundary of the whiteboard application.

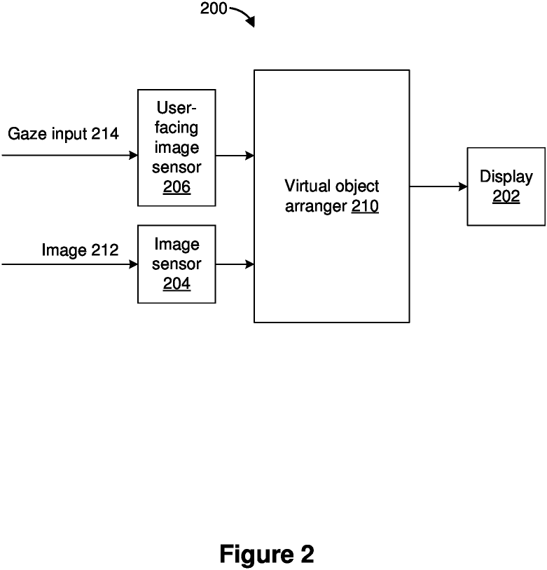

FIG. 2 is a block diagram of an example user interface engine 200. In some implementations, the user interface engine 200 resides at (e.g., is implemented by) the electronic device 102 shown in FIGS. 1A-1E. In various implementations, the user interface engine 200 organizes virtual objects within an extended reality (XR) environment at least in part by displaying a movement of a virtual object to an object placement location proximate to a user focus location that is determined based on a gaze input. The user interface engine 200 may include a display 202, one or more processors, an image sensor 204, a user-facing image sensor 206, and/or other input or control device(s).

While pertinent features are illustrated, those of ordinary skill in the art will appreciate from the present disclosure that various other features have not been illustrated for the sake of brevity and so as not to obscure more pertinent aspects of the implementations disclosed herein. Those of ordinary skill in the art will also appreciate from the present disclosure that the functions and sub-functions implemented by the user interface engine 200 can be combined into one or more systems and/or further sub-divided into additional subsystems, and that the functionality described below is provided as merely one example configuration of the various aspects and functions described herein.

In some implementations, the user interface engine 200 includes a display 202. The display 202 displays one or more virtual objects, e.g., the virtual objects 110, in an XR environment, such as the XR environment 108 of FIGS. 1A-1E. A virtual object arranger 210 may obtain a user input corresponding to a command to associate a virtual object with a region of the XR environment. For example, the image sensor 204 may receive an image 212. The image 212 may be a still image or a video feed comprising a series of image frames. The image 212 may include a set of pixels representing an extremity of the user. The virtual object arranger 210 may perform image analysis on the image 212 to detect a gesture input performed by a user. The gesture input may be, for example, a flinging gesture extending in a direction toward the region with which the user wishes to associate the virtual object.

In some implementations, the virtual object arranger 210 obtains a gaze input 214 that corresponds to a user focus location in the region. For example, the user-facing image sensor 206 may capture an image of the user’s eyes. The virtual object arranger 210 may perform image analysis on the image to determine locations of the user’s pupils. Based on the determined locations of the user’s pupils, the virtual object arranger 210 may determine a gaze vector corresponding to the user focus location. For example, if the region includes a surface, the user focus location may correspond to a location at which the gaze vector intersects the surface.

In some implementations, the virtual object arranger 210 obtains a confirmation input to confirm the selection of the user focus location. For example, the virtual object arranger 210 may use an accelerometer, gyroscope, and/or inertial measurement unit (IMU) to sense a head pose of the user. The virtual object arranger 210 may use the image sensor 204 to detect a gesture performed by the user. In some implementations, the confirmation input comprises a gaze vector that is maintained for at least a threshold duration. In some implementations, the confirmation input comprises an audio input, such as a voice command.

In some implementations, the virtual object arranger 210 determines an object placement location for the virtual object. The object placement location is proximate the user focus location. The object placement location may coincide with the user focus location, for example, if no other virtual objects are proximate the user focus location. In some implementations, if another virtual object is proximate the user focus location, the object placement location is selected to satisfy a threshold condition, e.g., ensuring that virtual objects are at least a threshold distance apart from one another. In some implementations, movements of other virtual objects that are proximate the user focus location are displayed to accommodate placement of the virtual object at the user focus location.

In some implementations, the virtual object arranger 210 determines the object placement location to satisfy a boundary condition. For example, if the user focus location is proximate a boundary of the region, the virtual object arranger 210 may select an object placement location that allows the virtual object to be displayed proximate the user focus location, while remaining partially or entirely within the region.

In some implementations, the display 202 displays a movement of the virtual object to the object placement location. If another virtual object is also proximate the user focus location, the display 202 may display a movement of the other virtual object so that the displayed virtual objects are at least a threshold distance apart. In some implementations, movements of multiple virtual objects may be displayed to accommodate the display of the virtual objects proximate the user focus location.

In some implementations, the user focus location is in a region that is associated with a physical element in the XR environment. The region may be associated with a portion of the physical element. For example, the gaze vector may intersect a surface of the physical element. In some implementations, when the display 202 displays a movement of the virtual object to an object placement location that is associated with a physical element, the appearance of the virtual object is modified. For example, a display size of the virtual object may be determined based on the size of the physical element, e.g., so that the virtual object is scaled proportionately to the physical element. In some implementations, the virtual object may be rotated based on an orientation of the physical element. For example, the virtual object may be rotated so that it appears to rest on the physical element.

In some implementations, the display 202 displays a visual effect that emanates from the object placement location. For example, an area around the object placement location may be animated to exhibit a rippling effect. As another example, an area around the object placement location may be animated to exhibit a distortion effect. In some implementations, an area around the object placement location may be animated to exhibit a shimmering effect. Displaying a visual effect emanating from the object placement location may facilitate locating the virtual object in the XR environment.

In some implementations, after the virtual object is displayed at the object placement location, the user may manipulate the virtual object. For example, the user may move the virtual object, e.g., to adjust the positioning of the virtual object. In some implementations, the virtual object arranger 210 obtains an object selection input that corresponds to a user selection of the virtual object. For example, the object selection input may include an untethered user input, such as a second gaze input obtained by the user-facing image sensor 206.

In some implementations, the virtual object arranger 210 obtains a confirmation input to confirm the selection of the virtual object. For example, the virtual object arranger 210 may use an accelerometer, gyroscope, and/or inertial measurement unit (IMU) to sense a head pose of the user. The virtual object arranger 210 may use the image sensor 204 to detect a gesture performed by the user. In some implementations, the confirmation input comprises a gaze vector that is maintained for at least a threshold duration. In some implementations, the confirmation input comprises an audio input, such as a voice command. In some implementations, the virtual object arranger 210 obtains the confirmation input from a user input device, such as a keyboard, mouse, stylus, and/or touch-sensitive display.

In some implementations, the virtual object arranger 210 obtains a manipulation user input. For example, the virtual object arranger 210 may use the image sensor 204 to detect a gesture performed by the user. The display 202 may display a manipulation of the virtual object in the XR environment based on the manipulation user input.

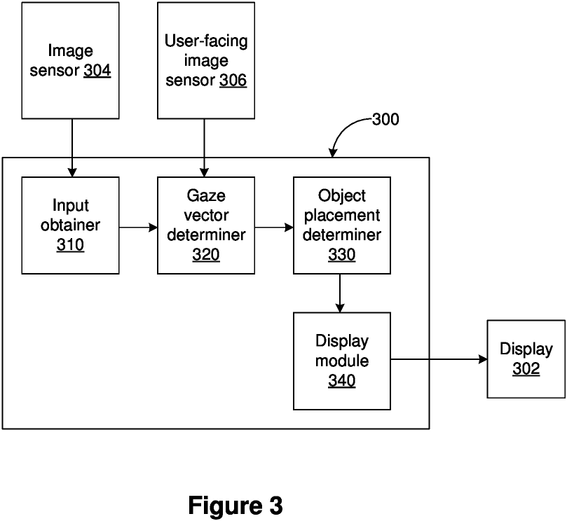

FIG. 3 is a block diagram of an example virtual object arranger 300 according to some implementations. In various implementations, the virtual object arranger 300 organizes virtual objects within an extended reality (XR) environment at least in part by displaying a movement of a virtual object to an object placement location proximate to a user focus location that is determined based on a gaze input.

In some implementations, the virtual object arranger 300 implements the virtual object arranger 210 shown in FIG. 2. In some implementations, the virtual object arranger 300 resides at (e.g., is implemented by) the electronic device 102 shown in FIGS. 1A-1E. The virtual object arranger 300 may include a display 302, one or more processors, an image sensor 304, a user-facing image sensor 306, and/or other input or control device(s).

While pertinent features are illustrated, those of ordinary skill in the art will appreciate from the present disclosure that various other features have not been illustrated for the sake of brevity and so as not to obscure more pertinent aspects of the implementations disclosed herein. Those of ordinary skill in the art will also appreciate from the present disclosure that the functions and sub-functions implemented by the virtual object arranger 300 can be combined into one or more systems and/or further sub-divided into additional subsystems; and that the functionality described below is provided as merely one example configuration of the various aspects and functions described herein.

In some implementations, the display 302 displays a user interface in an extended reality (XR) environment. The user interface may include one or more virtual objects that are displayed the XR environment. A user may interact with a virtual object, e.g., using gestures, such as pinch and/or pull gestures, to manipulate the virtual object. In some implementations, an input obtainer 310 obtains a user input corresponding to a command to associate a virtual object with a region of the XR environment. For example, after the user manipulates the virtual object, the user may wish to return the virtual object to a region of the XR environment.

In some implementations, the input obtainer 310 obtains an image from the image sensor 304. The image may be a still image or a video feed comprising a series of image frames. The image may include a set of pixels representing an extremity of the user. The input obtainer 310 may perform image analysis on the image to detect a gesture input performed by a user. The gesture input may be, for example, a flinging gesture extending in a direction toward the region with which the user wishes to associate the virtual object.

In some implementations, the input obtainer 310 obtains the user input from a user input device. For example, the user input may include an audio input, such as a voice command. In some implementations, the input obtainer 310 obtains the user input from a keyboard, mouse, stylus, and/or touch-sensitive display.

In some implementations, a gaze vector determiner 320 obtains a gaze input that corresponds to a user focus location in the region. For example, the user-facing image sensor 306 may capture an image of the user’s eyes. The gaze vector determiner 320 may perform image analysis on the image to determine locations of the user’s pupils. Based on the determined locations of the user’s pupils, the gaze vector determiner 320 may determine a gaze vector corresponding to the user focus location. For example, if the region includes a surface, the user focus location may correspond to a location at which the gaze vector intersects the surface.

In some implementations, the gaze vector determiner 320 obtains a confirmation input to confirm the selection of the user focus location. For example, the gaze vector determiner 320 may use an accelerometer, gyroscope, and/or inertial measurement unit (IMU) to sense a head pose of the user. The confirmation input may include a gesture performed by the user that is represented in an image captured by the image sensor 304. In some implementations, the confirmation input comprises a gaze vector that is maintained for at least a threshold duration. In some implementations, the confirmation input comprises an audio input, such as a voice command.

In some implementations, an object placement determiner 330 determines an object placement location for the virtual object based on the user focus location. The object placement location is proximate the user focus location. The object placement determiner 330 may determine the object placement location to be coincident with the user focus location if the user focus location is at least a threshold distance away from other virtual objects or region boundaries.

If placing the virtual object at the user focus location would cause the virtual object to be within a threshold distance of another virtual object or within a threshold distance of a region boundary, the object placement determiner 330 may determine the object placement location to be separated from the user focus location. For example, the object placement determiner 330 may locate the object placement location so that it is at least a threshold distance from other virtual objects and/or at least a threshold distance from any region boundaries. In some implementations, the object placement determiner 330 adjusts the location or locations of one or more other virtual objects to maintain at least a threshold distance between virtual objects. The object placement determiner 330 may adjust the location or locations of other virtual objects independently of whether the object placement location is coincident with or separate from the user focus location.

In some implementations, a display module 340 causes the display 302 to display a movement of the virtual object to the object placement location in the XR environment. The display module 340 may cause the display 302 to display a visual effect that emanates from the object placement location to enhance visibility of the virtual object and facilitate locating the virtual object in the XR environment. For example, the display module 340 may animate an area around the object placement location to exhibit a rippling effect. As another example, the display module 340 may animate an area around the object placement location to exhibit a distortion effect. In some implementations, the display module 340 animates an area around the object placement location to exhibit a shimmering effect.

In some implementations, the display module 340 modifies the appearance of the virtual object, e.g., if the object placement location is in a region that is associated with a physical element (e.g., a surface of the physical element) in the XR environment. For example, the display module 340 may determine a display size of the virtual object based on the size of the physical element, e.g., so that the virtual object is scaled proportionately to the physical element. In some implementations, the display module 340 may rotate the virtual object based on an orientation of the physical element. For example, the virtual object may be rotated so that it appears to rest on the physical element.

In some implementations, the display module 340 modifies the display of other virtual objects. For example, movements of other virtual objects that are proximate the user focus location may be displayed to accommodate placement of the virtual object at the user focus location.

In some implementations, after the virtual object is displayed at the object placement location, the user may manipulate the virtual object. For example, the user may move the virtual object, e.g., to adjust the positioning of the virtual object. In some implementations, the input obtainer 310 obtains an object selection input that corresponds to a user selection of the virtual object. For example, the object selection input may include an untethered user input, such as a second gaze input obtained by the user-facing image sensor 306.

In some implementations, a confirmation input is obtained to confirm the selection of the virtual object. For example, the confirmation input may include a head pose of the user as sensed by an accelerometer, gyroscope, and/or inertial measurement unit (IMU). As another example, the image sensor 304 may capture an image representing a gesture performed by the user. In some implementations, the confirmation input comprises a gaze vector that is maintained for at least a threshold duration. In some implementations, the confirmation input comprises an audio input, such as a voice command. In some implementations, the confirmation input is obtained from a user input device, such as a keyboard, mouse, stylus, and/or touch-sensitive display.

In some implementations, the input obtainer 310 obtains a manipulation user input. For example, the input obtainer 310 may use the image sensor 304 to detect a gesture performed by the user. The display 302 may display a manipulation of the virtual object in the XR environment based on the manipulation user input.

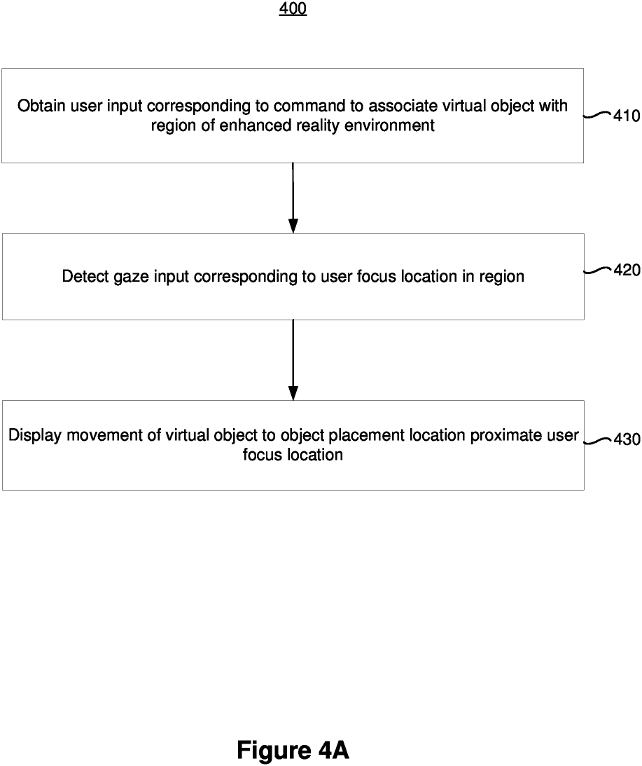

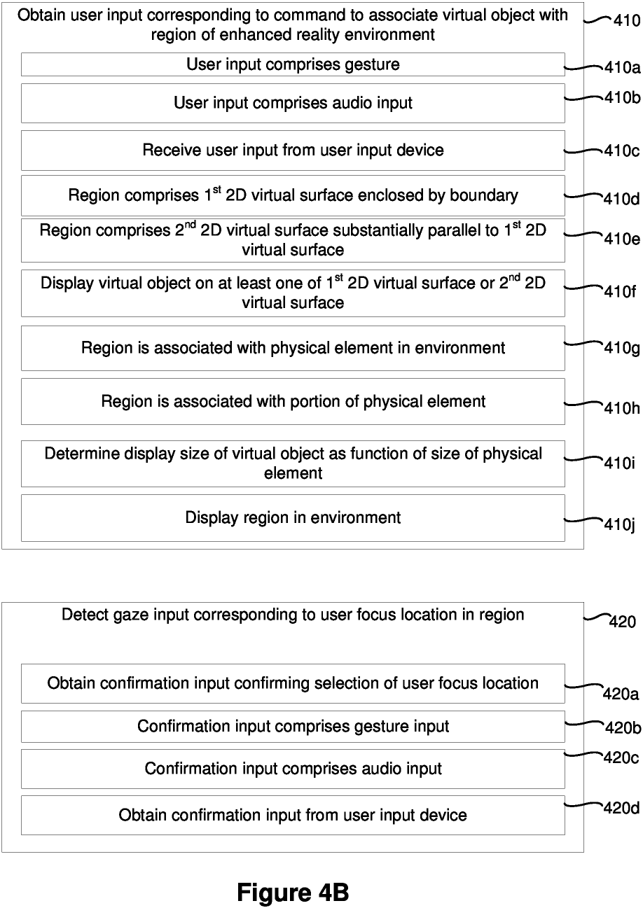

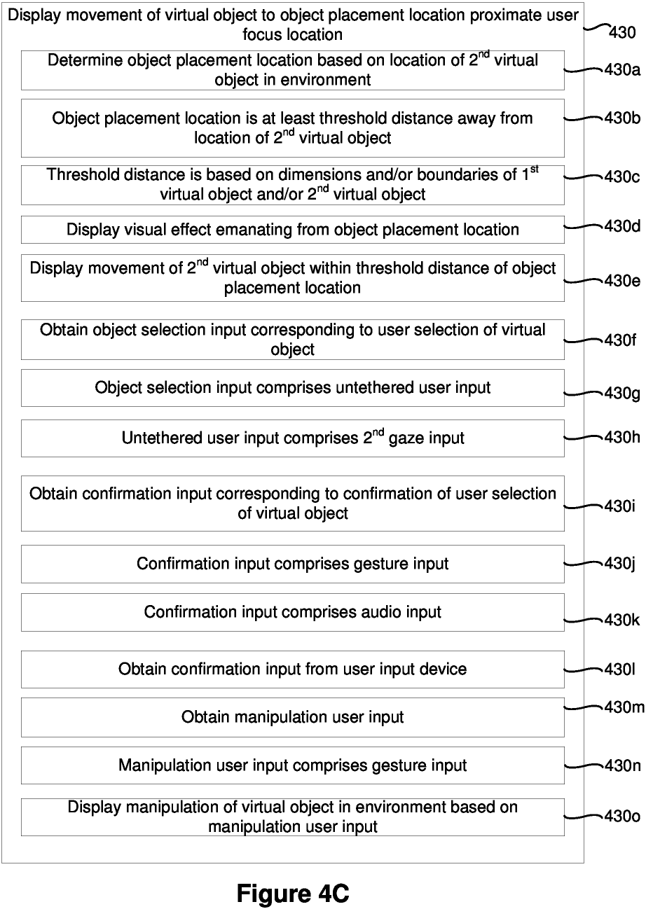

FIGS. 4A-4C are a flowchart representation of a method 400 for organizing virtual objects within an XR environment in accordance with some implementations. In various implementations, the method 400 is performed by a device (e.g., the electronic device 102 shown in FIGS. 1A-1E). In some implementations, the method 400 is performed by processing logic, including hardware, firmware, software, or a combination thereof. In some implementations, the method 400 is performed by a processor executing code stored in a non-transitory computer-readable medium (e.g., a memory). Briefly, in various implementations, the method 400 includes obtaining a user input corresponding to a command to associate a virtual object with a region of an XR environment, obtaining a gaze input corresponding to a user focus location in the region, and displaying a movement of the virtual object to an object placement location proximate the user focus location.

In some implementations, a user interface including one or more virtual objects is displayed in an XR environment. A user may interact with a virtual object, e.g., using gestures, such as pinch and/or pull gestures, to manipulate the virtual object. Referring to FIG. 4A, as represented by block 410, in various implementations, the method 400 includes detecting a gesture corresponding to a command to associate a virtual object with a region of an extended reality (XR) environment. For example, after the user manipulates the virtual object, the user may wish to return the virtual object to a region of the XR environment.

Referring to FIG. 4B, as represented by block 410a, the user input may comprise a gesture. For example, the electronic device 102 may capture an image, such as a still image or a video feed comprising a series of image frames. The image may include a set of pixels representing an extremity of the user. The electronic device 102 may perform image analysis on the image to detect a gesture input performed by a user. The gesture input may be, for example, a flinging gesture extending in a direction toward the region with which the user wishes to associate the virtual object.

In some implementations, as represented by block 410b, the user input comprises an audio input. For example, the electronic device 102 may include an audio sensor that receives a voice command from the user. As represented by block 410c, in some implementations, the user input is obtained from a user input device. For example, the user input may be obtained from a keyboard, mouse, stylus, and/or touch-sensitive display.

The command to associate the virtual object with a region of the XR environment may associate the virtual object with different types of regions. In some implementations, as represented by block 410d, the region of the XR environment includes a first two-dimensional virtual surface enclosed by a boundary, such as the two-dimensional virtual surface 114a, as represented in FIG. 1A. In some implementations, as represented by block 410e, the region of the XR environment also includes a second two-dimensional virtual surface, such as the two-dimensional virtual surface 114b. The second two-dimensional virtual surface may be substantially parallel to the first two-dimensional virtual surface. The two-dimensional virtual surfaces and the space between them may define a region in the XR environment. As represented by block 410f, the virtual object may be displayed on at least one of the first two-dimensional virtual surface or the second two-dimensional virtual surface. In some implementations, the virtual object is displayed in the space between the first and second two-dimensional virtual surfaces.

In some implementations, as represented by block 410g, the region of the XR environment is associated with a physical element in the XR environment. For example, the region may be associated with a physical table that is present in the XR environment. In some implementations, as represented by block 410h, the region of the XR environment is associated with a portion of the physical element. For example, the region may be associated with a tabletop surface of the physical table.

As disclosed herein and as represented by block 410i, in some implementations, a display size of the virtual object is determined as a size of the physical element. For example, the virtual object may be enlarged or reduced so that the virtual object is scaled proportionately to the physical element. In some implementations, the virtual object is rotated based on an orientation of the physical element. For example, the virtual object may be rotated so that it appears to rest on the physical element.

In some implementations, as represented by block 410j, the method 400 includes displaying the region in the XR environment. For example, the region may not correspond to a physical element and may be displayed in an unoccupied space in the user’s field of view.

In various implementations, as represented by block 420, the method 400 includes detecting a gaze input corresponding to a user focus location in the region. For example, a user-facing image sensor may capture an image of the user’s eyes. Image analysis may be performed on the image to determine locations of the user’s pupils. Based on the determined locations of the user’s pupils, a gaze vector corresponding to the user focus location may be determined. For example, if the region includes a surface, the user focus location may correspond to a location at which the gaze vector intersects the surface.

In some implementations, as represented by block 420a, a confirmation input is obtained that confirms a selection of the user focus location. For example, an accelerometer, gyroscope, and/or inertial measurement unit (IMU) may provide information relating to a head pose of the user. In some implementations, as represented by block 420b, the confirmation input includes a gesture input. For example, an image sensor may be used to detect a gesture performed by the user. In some implementations, the confirmation input comprises a gaze vector that is maintained for at least a threshold duration. In some implementations, as represented by block 420c, the confirmation input comprises an audio input, such as a voice command. In some implementations, as represented by block 420d, the confirmation input is obtained from a user input device, such as a keyboard, mouse, stylus, or touch-sensitive display.

In various implementations, as represented by block 430, the method 400 includes displaying a movement of the virtual object to an object placement location that is based on (e.g., proximate) the user focus location. The object placement location may coincide with the user focus location, for example, if no other virtual objects are proximate the user focus location.

Referring to FIG. 4C, in some implementations, as represented by block 430a, the object placement location is determined based on a location of a second virtual object in the XR environment. For example, if a second virtual object is proximate the user focus location, the object placement location may be selected to satisfy a threshold condition. In some implementations, as represented by block 430b, the object placement location may be at least a threshold distance away from the location of the second virtual object, e.g., ensuring that virtual objects are at least a threshold distance apart from one another. In some implementations, as represented by block 430c, the threshold distance is based on the dimensions and/or boundaries of the first virtual object (e.g., the virtual object being placed) and/or the second virtual object. For example, a threshold distance may be ensured between edges of virtual objects to prevent virtual objects from occluding each other. In some implementations, movements of other virtual objects that are proximate the user focus location are displayed to accommodate placement of the virtual object at the user focus location.

In some implementations, the object placement location satisfies a boundary condition. For example, if the user focus location is proximate a boundary of the region, the object placement location may allow the virtual object to be displayed proximate the user focus location, while remaining partially or entirely within the region.

As represented by block 430d, the method 400 may include displaying a visual effect that emanates from the object placement location. For example, an area around the object placement location may be animated to exhibit a rippling effect. As another example, an area around the object placement location may be animated to exhibit a distortion effect. In some implementations, an area around the object placement location may be animated to exhibit a shimmering effect. Displaying a visual effect emanating from the object placement location may facilitate locating the virtual object in the XR environment.

In some implementations, movements of multiple virtual objects may be displayed, for example, to accommodate the display of multiple virtual objects proximate the user focus location. For example, as represented by block 430e, the method 400 may include displaying a movement of a second virtual object that is within a threshold distance of the object placement location. Movement of the second virtual object may be displayed to maintain at least a threshold distance between displayed virtual objects.

Virtual objects can be manipulated (e.g., moved) in the XR environment. In some implementations, as represented by block 430f, the method 400 includes obtaining an object selection input that corresponds to a user selection of the virtual object. As represented by block 430g, the object selection input may include an untethered user input. In some implementations, as represented by block 430h, the untethered input includes a second gaze input, e.g., distinct from the gaze input used to determine the user focus location.

In some implementations, as represented by block 430i, a confirmation input is obtained. The confirmation input corresponds to a confirmation of the user selection of the virtual object. For example, the electronic device 102 may use an accelerometer, gyroscope, and/or inertial measurement unit (IMU) to sense a head pose of the user. As represented by block 430j, an image sensor may be used to detect a gesture performed by the user. In some implementations, as represented by block 430k, the confirmation input may include an audio input, such as a voice command. As represented by block 430l, in some implementations, the confirmation input is obtained from a user input device, such as a keyboard, mouse, stylus, or touch-sensitive display. In some implementations, the confirmation input comprises a gaze vector that is maintained for at least a threshold duration.

In some implementations, as represented by block 430m, the method 400 includes obtaining a manipulation user input. The manipulation user input corresponds to a manipulation, e.g., a movement, of the virtual object. In some implementations, as represented by block 430n, the manipulation user input includes a gesture input. As represented by block 430o, in some implementations, the method 400 includes displaying a manipulation of the particular virtual object in the XR environment based on the manipulation user input. For example, the user may perform a drag and drop gesture in connection with a selected virtual object. The electronic device 102 may display a movement of the selected virtual object from one area of the XR environment to another area in accordance with the gesture.

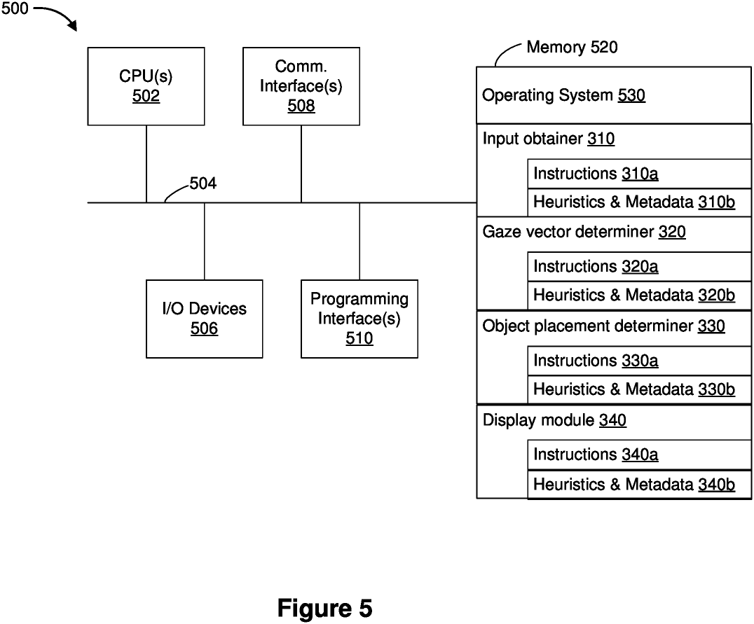

FIG. 5 is a block diagram of a device 500 enabled with one or more components of a device (e.g., the electronic device 102 shown in FIGS. 1A-1E) in accordance with some implementations. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 500 includes one or more processing units (CPUs) 502, one or more input/output (I/O) devices 506 (e.g., the image sensor 114 shown in FIGS. 1A-1E), one or more communication interface(s) 508, one or more programming interface(s) 510, a memory 520, and one or more communication buses 504 for interconnecting these and various other components.

In some implementations, the communication interface 508 is provided to, among other uses, establish, and maintain a metadata tunnel between a cloud-hosted network management system and at least one private network including one or more compliant devices. In some implementations, the one or more communication buses 504 include circuitry that interconnects and controls communications between system components. The memory 520 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 520 optionally includes one or more storage devices remotely located from the one or more CPUs 502. The memory 520 comprises a non-transitory computer readable storage medium.

In some implementations, the memory 520 or the non-transitory computer readable storage medium of the memory 520 stores the following programs, modules and data structures, or a subset thereof including an optional operating system 530, the input obtainer 310, the gaze vector determiner 320, the object placement determiner 330, and the display module 340. As described herein, the input obtainer 310 may include instructions 310a and/or heuristics and metadata 310b for obtaining a user input corresponding to a command to associate a virtual object with a region of the XR environment. As described herein, the gaze vector determiner 320 may include instructions 320a and/or heuristics and metadata 320b for obtaining a gaze input that corresponds to a user focus location in the region. As described herein, the object placement determiner 330 may include instructions 330a and/or heuristics and metadata 330b for determining an object placement location for the virtual object based on the user focus location. As described herein, the display module 340 may include instructions 340a and/or heuristics and metadata 340b for causing a display to display a movement of the virtual object to the object placement location in the XR environment.

It will be appreciated that FIG. 5 is intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in FIG. 5 could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

It will be appreciated that the figures are intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in the figures could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device including a display, one or more processors, and a non-transitory memory:
detecting a gesture corresponding to a command to associate a virtual object with a region of an environment;
detecting a gaze input corresponding to a user focus location in the region; and
displaying a movement of the virtual object to an object placement location based on the user focus location.

2. The method of claim 1, wherein the region of the environment comprises a first two-dimensional virtual surface enclosed by a boundary.

3. The method of claim 2, wherein the region of the environment further comprises a second two-dimensional virtual surface substantially parallel to the first two-dimensional virtual surface.

4. The method of claim 3, further comprising displaying the virtual object on at least one of the first two-dimensional virtual surface or the second two-dimensional virtual surface.

5. The method of claim 1, wherein the region of the environment is associated with a physical element in the environment.

6. The method of claim 5, wherein the region of the environment is associated with a portion of the physical element.

7. The method of claim 5, further comprising determining a display size of the virtual object as a function of a size of the physical element.

8. The method of claim 1, further comprising displaying the region in the environment.

9. The method of claim 1, further comprising obtaining a confirmation input confirming a selection of the user focus location.

10. The method of claim 9, wherein the confirmation input comprises a gesture input.

11. The method of claim 9, wherein the confirmation input comprises an audio input.

12. The method of claim 9, further comprising obtaining the confirmation input from a user input device.

13. The method of claim 1, further comprising determining the object placement location based on a location of a second virtual object in the environment.

14. The method of claim 13, wherein the object placement location is at least a threshold distance away from the location of the second virtual object.

15. The method of claim 14, wherein the threshold distance is based on at least one of a dimension or a boundary of at least one of the first virtual object or the second virtual object.

16. The method of claim 1, further comprising displaying a visual effect emanating from the object placement location.

17. The method of claim 1, further comprising displaying a movement of a second virtual object within a threshold distance of the object placement location.

18. The method of claim 1, further comprising obtaining an object selection input corresponding to a user selection of the virtual object.

19. A device comprising:
one or more processors;
a non-transitory memory; and
one or more programs stored in the non-transitory memory, which, when executed by the one or more processors, cause the device to:
detect a gesture corresponding to a command to associate a virtual object with a region of an environment;
detect a gaze input corresponding to a user focus location in the region; and
display a movement of the virtual object to an object placement location based on the user focus location.

20. A non-transitory memory storing one or more programs, which, when executed by one or more processors of a device, cause the device to:
detect a gesture corresponding to a command to associate a virtual object with a region of an environment;
detect a gaze input corresponding to a user focus location in the region; and
display a movement of the virtual object to an object placement location based on the user focus location.
